(19) United States
(12) Patent Application Publication
(10) Pub. No.: US 2003/0233447 A1
(43) Pub. Date: Dec. 18, 2003

(54) Apparatus and methods for monitoring content requested by a client device

(75) Inventors: Craig William Fellenstein, Brookfield, CT (US); Carl Phillip Gusler, Austin, TX (US); Rick Allen Hamilton II, Charlottesville, VA (US)

Correspondence Address: Duke W. Yee, Carstens, Yee & Cahoon, LLP, P.O. Box 802334, Dallas, TX, 75380, US

(73) Assignee: International Business Machines Corporation, Armonk, NY (US)

(21) Appl. No.: 10/172,186

(22) Filed: Jun. 13, 2002

(51) Int. Cl. G06F 15/173

(52) U.S. Cl. 709/224; 709/203

(57) ABSTRACT

Apparatus and methods for monitoring content requested by a user of a computing device. Logs of web browsing sessions may be generated and analyzed to determine if inappropriate content is being viewed by a monitored individual. With one exemplary embodiment, a user is registered with a service provider such that an indication as to whether or not logs of the user's web browsing sessions should be stored. Thereafter, when the user logs onto the service provider to obtain access to web sites, the service provider performs a lookup in the user database to determine if the user is to be monitored. If the user is to be monitored, when the user issues a content request using his/her web browser application, the content request is intercepted by the service provider and a copy of the content request is stored in a secure log on the service provider. The content request may then be completed in a normal fashion. In an alternative embodiment, when the content request is forwarded to the content provider, the content provider responds with the requested content which is then intercepted by the service provider. A copy of this content, e.g., the web page, may be stored in association with the log entry for later review by an authorized individual. The storing of such copies of the content may be performed for each content request or only for “questionable” content as determined using an analysis engine.

### RELATED APPLICATION

The present invention is directed to similar subject matter as commonly assigned and co-pending U.S. patent application Ser. No. 10/004,925 (Attorney Docket No. AUS920011013US1) entitled “Apparatus and Method for Monitoring and Analyzing Instant Messaging Account Transcripts,” and U.S. patent application Ser. No. 10/004,955 (Attorney Docket No. AUS920010953US1) entitled “Apparatus and Method for Monitoring Instant Messaging Accounts,” both filed Dec. 5, 2001.

### BACKGROUND OF THE INVENTION

1. Technical Field

The present invention is directed to an improved data processing system. More specifically, the present invention is directed to apparatus and methods for monitoring content requested by a client device.

2. Description of Related Art

With the phenomenal growth of the Internet and the proliferation of web sites into today's society, what once was an esoteric computer-based pursuit has become commonplace. The ability of computer users of all ages, from very young to very old, to find desired content on the web has become and accepted and expected part of life. However, despite the fact that this powerful tool has incredibly positive uses, the dangers and unexpected consequences of web usage must also be considered, along with ways to overcome these undesirable effects.

Current technology for protecting the home computer remains an inexact science, and promises to be so for some time to come. Filters, which operate on terms found in the text of a web page or Universal Resource Locator (URL), may prevent some obvious sites from being downloaded to the home browser, but they still permit other “undesirable” web sites to be viewed by minors. Furthermore, the use of filters may result in legitimate sites being blocked, as may be noted in the well publicized stories of “Beaver College” in Pennsylvania being screened out by many filter applications.

Furthermore, it may be noted that filters are only one part of the equation in controlling what underage children view. For instance, many parents do not want to undertake the efforts and incur the expense associated with obtaining and maintaining application of filters. Moreover, even if they do expend the effort and money to obtain filters for their browser applications, despite the best efforts of filter designers to block other non-pornography but undesirable web sites (such as racist or weapon-related sites), it is still possible for minors to gain access to these web sites. The computer literate minor can then cover his or her tracks and obscure the visit to the questionable web site by calling up the history file and deleting the entry for that web site from the history file. If the history file is then later viewed by a parent or guardian, no trace of the controversial site will be found if such editing is performed.

Still further, if a parent or guardian installs a filter application with a particular web browser application, the filter application will operate only with that web browser. Thus, if a minor loads a different browser application onto the home computer and uses it to access web sites, the filter application will not be enabled. As a result, there is no protection with regard to the minor's viewing questionable content.

Thus, it would be beneficial to have an apparatus and method that provides a secure log of web sites visited by a monitored individual. It would further be beneficial to have mechanisms for protecting the log such that only authorized individuals may be able to gain access to it. It would also be beneficial to have a mechanism to provide automatic notification to an authorized individual of the web sites visited by a monitored individual.

### SUMMARY OF THE INVENTION

The present invention provides apparatus and methods for monitoring content requested by a user of a computing device. The present invention provides a mechanism by which logs of web browsing sessions may be generated and analyzed to determine if inappropriate content is being viewed by a monitored individual. With one exemplary embodiment of the present invention, a user is registered with a service provider such that an indication as to whether or not logs of the user's web browsing sessions should be stored.

Thereafter, when the user logs onto the service provider to obtain access to web sites, the service provider performs a lookup in the user database to determine if the user is to be monitored. If the user is to be monitored, when the user issues a content request using his/her web browser application, the content request is intercepted by the service provider and a copy of the content request is stored in a secure log on the service provider. The content request may then be completed in a normal fashion.

In an alternative embodiment, when the content request is forwarded to the content provider, the content provider responds with the requested content which is then intercepted by the service provider. A copy of this content, e.g., the web page, may be stored in association with the log entry for later review by an authorized individual. The storing of such copies of the content may be performed for each content request or only for “questionable” content as determined using an analysis engine.

Moreover, the analysis engine, upon determining that requested content is “questionable” may be configured so as to not forward the content to the requesting computing device. Thus, rather than sending the questionable content to the computing device being used by the monitored individual, a web page indicating that the requested content could not be retrieved may be sent. Such a web page may resemble a common error web page generated by the web browser application. In this way, the questionable content is not provided to the monitored individual and yet the monitored individual is not made aware of the fact that they are being monitored.

The log, and optionally the copies of the requested content, are stored on the service provider in a secured file or database. For example, the log and copies of requested content may be stored in a password protected file such that only individuals having the proper user identification and password may access the log and copies of requested content. Since the log and copies of the requested content are stored on service provider and are generated based on an Internet Protocol (IP) address, service provider physical port identifier, or the like, the user cannot circumvent or edit the monitoring of their requests by editing a locally stored history file or using a different web browser application.

In addition, the present invention may notify an authorized individual when new log entries have been entered. This notification may be provided, for example, via electronic mail, pager service, automated telephone calls, or any other mechanism for notifying the authorized individual of new log entries. The authorized individual may then log onto the service provider and obtain access to the log and copies of requested content via a web page or the like. Alternatively, the log may be attached to the notification in a secure manner such that the authorized user has instant access to the log rather than having to log onto the service provider.

These and other features and advantages of the present invention will be described in, or will become apparent to those of ordinary skill in the art in view of, the following detailed description of the preferred embodiments.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is an exemplary diagram of a distributed computer system in accordance with a preferred embodiment of the present invention;

FIG. 2 is an exemplary block diagram of a server apparatus;

FIG. 3 is an exemplary diagram of a client device;

FIG. 4 is an exemplary diagram illustrating the communication between elements of a distributed network in accordance with one embodiment of the present invention;

FIG. 5 is an exemplary block diagram of a monitoring agent according to one embodiment of the present invention;

FIG. 6 is a flowchart outlining an exemplary operation of the present invention when generating a log of a web browsing session; and

FIG. 7 is a flowchart outlining an exemplary operation of the present invention when generating a log notification.

### DETAILED DESCRIPTION OF THE PREFERRED EMBODIMENTS

The present invention provides an apparatus and method for monitoring web sites visited by monitored individuals. The present invention is implemented in a distributed data processing environment in which computing devices are coupled to one another and may communicate with one another via network links. The following description is intended to provide a background description of an exemplary distributed data processing environment in which the present invention may be implemented.

It should be noted that, while the content referred to in the following description will be described as “web sites” or “web pages,” the present invention is not limited to operation in the World Wide Web. Rather, the present invention is applicable to any computing network in which content may be retrievable from a content source and transmitted to a requesting computing device.

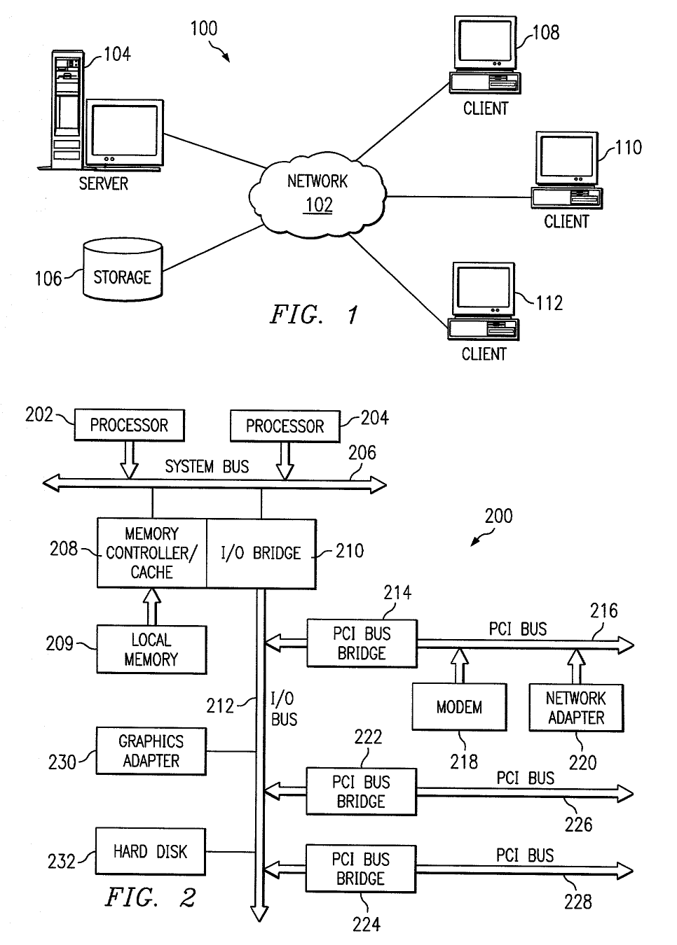

With reference now to the figures, FIG. 1 depicts a pictorial representation of a network of data processing systems in which the present invention may be implemented. Network data processing system 100 is a network of computers in which the present invention may be implemented. Network data processing system 100 contains a network 102, which is the medium used to provide communications links between various devices and computers connected together within network data processing system 100. Network 102 may include connections, such as wire, wireless communication links, or fiber optic cables.

In the depicted example, servers 104-105 are connected to network 102 along with storage unit 106. In addition, clients 108, 110, and 112 are connected to network 102. These clients 108, 110, and 112 may be, for example, personal computers or network computers. In the depicted example, servers 104-105 provide data, such as boot files, operating system images, and applications to clients 108-112. Clients 108, 110, and 112 are clients to servers 104-105. Network data processing system 100 may include additional servers, clients, and other devices not shown.

In the depicted example, network data processing system 100 is the Internet with network 102 representing a worldwide collection of networks and gateways that use the TCP/IP suite of protocols to communicate with one another. At the heart of the Internet is a backbone of high-speed data communication lines between major nodes or host computers, consisting of thousands of commercial, government, educational and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for the present invention.

Referring to FIG. 2, a block diagram of a data processing system that may be implemented as a server, such as server 104 or 105 in FIG. 1, is depicted in accordance with a preferred embodiment of the present invention. Data processing system 200 may be a symmetric multiprocessor (SMP) system including a plurality of processors 202 and 204 connected to system bus 206. Alternatively, a single processor system may be employed. Also connected to system bus 206 is memory controller/cache 208, which provides an interface to local memory 209. I/O bus bridge 210 is connected to system bus 206 and provides an interface to I/O bus 212. Memory controller/cache 208 and I/O bus bridge 210 may be integrated as depicted.

Peripheral component interconnect (PCI) bus bridge 214 connected to I/O bus 212 provides an interface to PCI local bus 216. A number of modems may be connected to PCI local bus 216. Typical PCI bus implementations will support four PCI expansion slots or add-in connectors. Communications links to clients 108-112 in FIG. 1 may be provided through modem 218 and network adapter 220 connected to PCI local bus 216 through add-in boards.

Additional PCI bus bridges 222 and 224 provide interfaces for additional PCI local buses 226 and 228, from which additional modems or network adapters may be supported. In this manner, data processing system 200 allows connections to multiple network computers. A memory-mapped graphics adapter 230 and hard disk 232 may also be connected to I/O bus 212 as depicted, either directly or indirectly.

Those of ordinary skill in the art will appreciate that the hardware depicted in FIG. 2 may vary. For example, other peripheral devices, such as optical disk drives and the like, also may be used in addition to or in place of the hardware depicted. The depicted example is not meant to imply architectural limitations with respect to the present invention.

The data processing system depicted in FIG. 2 may be, for example, an IBM e-Server pSeries system, a product of International Business Machines Corporation in Armonk, N.Y., running the Advanced Interactive Executive (AIX) operating system or LINUX operating system.

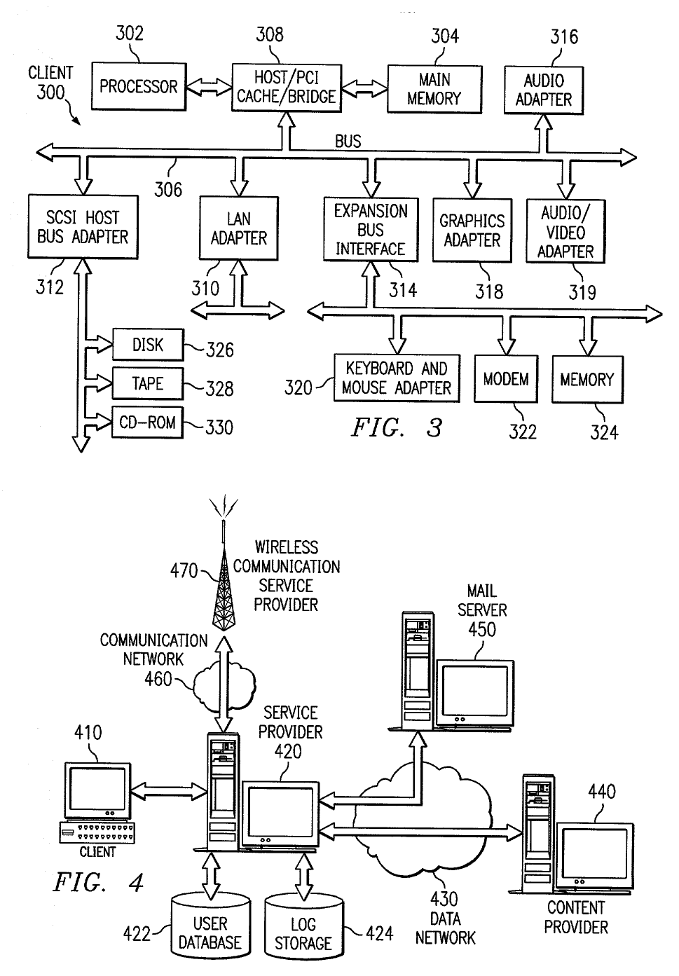

With reference now to FIG. 3, a block diagram illustrating a data processing system is depicted in which the present invention may be implemented. Data processing system 300 is an example of a client computer. Data processing system 300 employs a peripheral component interconnect (PCI) local bus architecture. Although the depicted example employs a PCI bus, other bus architectures such as Accelerated Graphics Port (AGP) and Industry Standard Architecture (ISA) may be used. Processor 302 and main memory 304 are connected to PCI local bus 306 through PCI bridge 308. PCI bridge 308 also may include an integrated memory controller and cache memory for processor 302. Additional connections to PCI local bus 306 may be made through direct component interconnection or through add-in boards.

In the depicted example, local area network (LAN) adapter 310, SCSI host bus adapter 312, and expansion bus interface 314 are connected to PCI local bus 306 by direct component connection. In contrast, audio adapter 316, graphics adapter 318, and audio/video adapter 319 are connected to PCI local bus 306 by add-in boards inserted into expansion slots. Expansion bus interface 314 provides a connection for a keyboard and mouse adapter 320, modem 322, and additional memory 324. Small computer system interface (SCSI) host bus adapter 312 provides a connection for hard disk drive 326, tape drive 328, and CD-ROM drive 330. Typical PCI local bus implementations will support three or four PCI expansion slots or add-in connectors.

An operating system runs on processor 302 and is used to coordinate and provide control of various components within data processing system 300 in FIG. 3. The operating system may be a commercially available operating system, such as Windows 2000 or XP, which is available from Microsoft Corporation. An object oriented programming system such as Java may run in conjunction with the operating system and provide calls to the operating system from Java programs or applications executing on data processing system 300. “Java” is a trademark of Sun Microsystems, Inc. Instructions for the operating system, the object-oriented operating system, and applications or programs are located on storage devices, such as hard disk drive 326, and may be loaded into main memory 304 for execution by processor 302.

Those of ordinary skill in the art will appreciate that the hardware in FIG. 3 may vary depending on the implementation. Other internal hardware or peripheral devices, such as flash ROM (or equivalent nonvolatile memory) or optical disk drives and the like, may be used in addition to or in place of the hardware depicted in FIG. 3. Also, the processes of the present invention may be applied to a multiprocessor data processing system.

As another example, data processing system 300 may be a stand-alone system configured to be bootable without relying on some type of network communication interface, whether or not data processing system 300 comprises some type of network communication interface. As a further example, data processing system 300 may be a personal digital assistant (PDA) device, which is configured with ROM and/or flash ROM in order to provide non-volatile memory for storing operating system files and/or user-generated data.

The depicted example in FIG. 3 and above-described examples are not meant to imply architectural limitations. For example, data processing system 300 also may be a notebook computer or hand held computer in addition to taking the form of a PDA. Data processing system 300 also may be a kiosk or a Web appliance.

As mentioned above, the present invention provides a mechanism for monitoring content requested by a client device. This content, in a preferred embodiment, is web pages from web sites established on server computing devices in the distributed data processing system, such as servers 104-105. With the present invention, a secured log of the content requested by the user of a client device is generated for later use by an authorized individual. In addition, copies of the content may be stored for later review. In addition, an analysis engine may be used to analyze the requested content and determine if questionable subject matter is present in the requested content. A notification device may also be used to notify the authorized individual of new entries to the log and/or the presence of questionable content.

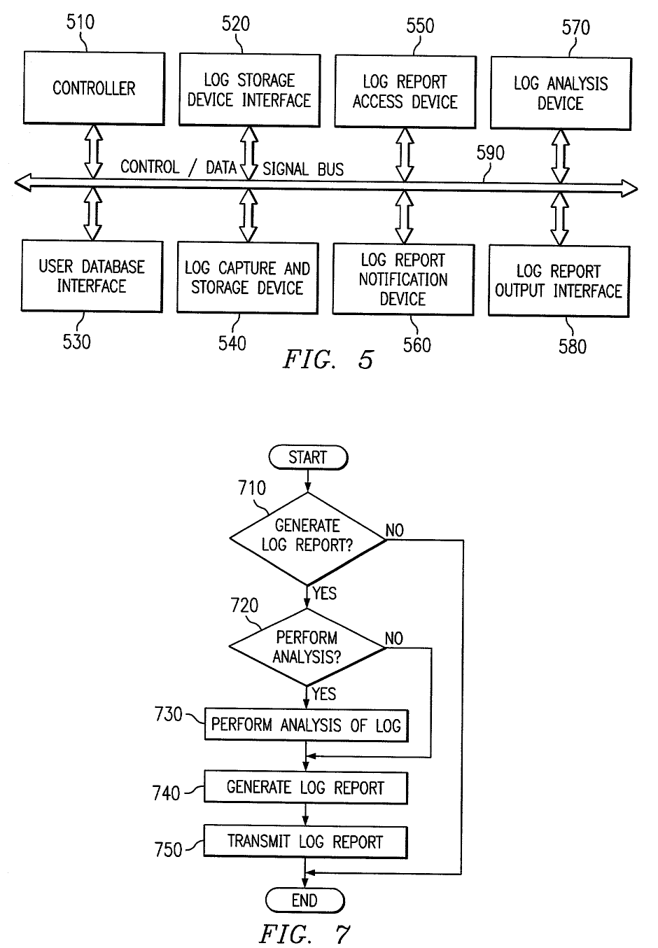

FIG. 4 is an exemplary diagram illustrating communication between devices in accordance with the present invention. As shown in FIG. 4, a client device 410 obtains access to content providers, such as content provider 440, via the service provider 420 and the data network 430. The service provider 420 provides a gateway for client device 410 to access the data network 430 and thus, content providers on the data network 430. In addition, the client device 410 may access electronic mail accounts on mail server 450 via the service provider 420 and data network 430.

In a preferred embodiment, the content provider 440 is a web server hosting one or more web sites that may be comprised of one or more web pages that are retrievable by the client device 410. Also in this preferred embodiment, service provider 420 is an Internet Service Provider (ISP) equipped with a monitoring agent (not shown) according to the present invention. The monitoring agent may be implemented as software instructions, hardware devices, or any combination of software and hardware without departing from the spirit and scope of the present invention. In a preferred embodiment, the monitoring agent is implemented as software instructions executed by one or more processors associated with the service provider 420.

Initially, when an owner of the client device 410 establishes an account with the service provider 420, the owner may also establish one or more user identities and passwords used for logging onto the service provider 420. These user identities may be identified as being subject to monitoring, user identities not subject to monitoring, and user identities of authorized users. A user identity that is subject to monitoring will have any content request transmitted by the client device 410 under that user identity logged in a content request log stored on the service provider 420. A user identity that is not subject to monitoring will not have content requests logged. A user identity that is an authorized user will not have content requests logged and further, may access content request logs for review. The account information, user identities, the user identity type (e.g., monitored, not monitored, or authorized), password information, and the like will be stored in user records of the user database 422 for later use by the service provider 420.

In addition to the above, authorized users may enter contact information indicating the manner by which the authorized user may be contacted regarding log entries and possible questionable content being requested by monitored user identities. This contact information may include, for example, an electronic mail address, a pager access number, a telephone number, or the like, to which notifications may be transmitted. Such contact information may be stored in association with the user identities having a monitored user identity type.

When a user of the client device 410 wishes to access content via the data network 430, the user enters his/her user identity and password into an application resident on the client device 410 which transmits a logon request to the service provider 420. The service provider 420 verifies the user identity and password by retrieving a corresponding user record from the user database and performing a comparison. If the user is verified, the service provider then negotiates a connection with the client device 410.

The negotiation of a connection with the client device 410 involves a number of different initiation functions. For example, the negotiation includes establishing a physical port of the service provider 420 through which data transmissions to and from the client device 410 will take place. The service provider 420 assigns an address, e.g., an IP address, to the client device 410 for use in communicating over the data network 430. The service provider 420 also generates a temporary registry of the settings and capabilities of the client device 410 for use during communication over the data network.

In addition to the above, the service provider 420 determines whether the user identity supplied by the client device 410 indicates that logs of content requests from the client device 410 should be created. Such a determination involves retrieving the user identity type from the user database 422 and determining which type of user identity was entered by the user of the client device 410.

If it is determined that the user identity indicates that log entries are to be generated for content requests sent by the user, the service provider 420 sets a flag in the temporary registry that indicates any content requests received over the identified physical port, and/or having the particular address assigned to the client device 410 by the service provider in a header of the content request, will be intercepted and a log entry for the content request will be generated. In addition, the temporary registry may include an identifier of the contact information to be used when informing the authorized user of new log entries and/or questionable content.

Having verified the user identity and password and established a connection between the client device 410 and the service provider 420, content requests may now be sent from the client device 410 to the service provider 420. Assuming that the user is to be monitored, these content requests will be received by the service provider 420 and a log entry in a content request log will be generated in the log storage device 424. The log entry may, for example, include the Universal Resource Locator (URL), IP address, time, date, and the like, of the content request.

The content request may then be forwarded to the content provider 440 over data network 430 in order to retrieve the requested content. The content provider 440 then transmits the requested content to the service provider 420 via the data network 430. The service provider 420 may then forward the requested content to the client device 410. An indicator of whether the content was actually transmitted to the client device 410 or not may also be stored in the content request log of the log storage device 424. This process of generating log entries in the content request log of the log storage device 424 may be repeated for each content request transmitted by the client device 410.

Once the user of the client device 410 logs off of the service provider 420, at predetermined times, or in the event of no activity for a predetermined period of time, the service provider 420 may generate a notification to the authorized user indicating that new log entries have been stored in the log storage device 424. This notification may take any of a number of forms. For example, the notification may be a standardized electronic mail message that is sent to the electronic mail address entered by the authorized user as being the electronic mail address to which notifications are to be sent. Further, the notification may take the form of a pager message sent to a pager number entered by the authorized user. Still further, the notification may take the form of a prerecorded message that may be output to an authorized user via conventional wired or wireless telephones. Any form of notification may be used without departing from the spirit and scope of the present invention.

In a preferred embodiment, the notification is sent by the service provider 420 as an electronic mail message to the electronic mail address of the authorized user. This causes the electronic mail message to be stored on mail server 450 until retrieval and removal by the authorized user. The electronic mail message may be a standardized electronic mail message that only informs the authorized user of changes to the log in the log storage device 424.

In an alternative embodiment, the electronic mail message may have the log, or only the new entries in the log, attached as an attachment to the electronic mail message. In such an alternative embodiment, the attachment may be password protected so that anyone gaining access to the authorized user's mail account will not be able to access the log without knowing the appropriate password.

In another preferred embodiment, the notification is sent as a pager or telephone message. In this preferred embodiment, the service provider 420 initiates a call to the authorized user's pager or telephone via the communication network 460 and wireless communication service provider 470. In the case of a pager notification, the notification may be a predetermined alphanumeric message of limited length. In the case of a telephone notification, the notification may take the form of a prerecorded message that is output once an off-hook condition is detected at the authorized user's telephone unit.

Upon receiving the notification, the authorized user may log onto the service provider 420 using his/her user identity and password. The user identity and password is verified by the service provider 420 and identified as belonging to an authorized user. As a result, the service provider 420 provides the user with the option to review content request logs in the log storage device 424 and perform maintenance on these logs. In reviewing the content request logs, the authorized user is provided with one or more web pages displaying the content request logs. These web pages may include interfaces through which the authorized user may delete log entries or entire logs as well as perform other maintenance operations including printing, copying, highlighting, and the like. In addition, the authorized user may select a log entry and thereby have an instance of their web browser initiated and the content associated with the log entry retrieved.

In a further embodiment of the present invention, rather than only storing a log entry of the content request transmitted by the client device 410, the service provider 420 may also store a copy of the actual content retrieved based on the content request. When the content requested by the client device 410 is received by the service provider 420, the service provider 420 may store a copy of the content in association with the log entry in the log storage device 424. Later, when the authorized user wishes to access the content request logs in the log storage device 424, the authorized user may also view the content associated with those log entries.

In yet another embodiment of the present invention, the monitoring agent of the service provider may be equipped with an analysis engine for analyzing the subject matter of the content requested. Such analysis engine may take the form of a filter or the like. For example, the analysis engine may analyze text of a web page, URL or other associated text and determine if certain suspect words or phrases are utilized. Based on this analysis, a determination may be made as to whether the web page may include potentially inappropriate content for the monitored individual.

Based on this analysis, a copy of the content may be stored in the log storage device 424, a notification may be sent to the authorized user, log entries in the content request log may be highlighted or otherwise made more apparent to a reviewing user, or the like. Thus, rather than storing copies of all content retrieved, the analysis engine of the present invention may be utilized to identify suspect content and store only the log entries and/or copies of content determined to be suspect. Moreover, with the analysis engine, notification may be made immediately upon a determination that the content requested may have potentially inappropriate content.

Moreover, rather than forwarding the requested content to the requesting client device 410, the service provider 420 may use the analysis engine to determine if that content potentially has inappropriate material. If so, the service provider 420 may not forward the requested content and may, instead, send a standard error web page to the client device 410. This standard web page may be similar to the web page generated by a web browser when a requested web page is not retrievable.

In yet another embodiment of the present invention, the service provider 420 may include a utility tool for parsing and analyzing the stored content request logs and/or copies of content to aid parents, guardians, and other authorized users, in identifying aspects of the content request logs and/or copies of content that may be of special need of attention. For example, the utility tool may provide a ranked list of URLs requested most frequently by the monitored individual, a ranked list of, a date/time distribution of content requests (for curfews, after-hours operation, parents out of town, etc.), filtering for interesting or dangerous text such as offensive language, offensive content, and an ability to save secondary content request logs that are pre-indexed and have been filtered to remove irrelevant or harmless content requests, such as by date or user identification.

The automated sifting and parsing of the content request logs to deliver this information to the guardian's fingertips allows review of potentially undesirable content requested by the minor in the shortest possible timeframe.

The content request logs in the log storage device 424 may be analyzed at the time that they are stored in the log storage device 424 or at a later time, such as in response to a request by an authorized user. The content request logs, and/or optionally the results of analysis of the content request logs, may be provided to the designated authorized user on a periodic basis, in response to a condition, such as the results of the analysis indicating a potential problem, in response to a request from the authorized user, or the like.

The functions of the present invention have been described as being part of the service provider 420 that is logged-onto by the client device 410. However, the present invention is not limited to such a configuration. Rather, the functions of the present invention may be implemented as part of the client device 410 or as a separate service provider from that of the service provider providing a gateway to the data network.

Thus, the present invention provides a sophisticated mechanism for monitoring the content requests submitted by a monitored individual via his/her client device. With the present invention, logs of such content requests may be stored based on whether they potentially contain inappropriate material. Furthermore, notifications may be transmitted automatically upon the identification of a content request whose requested content potentially contains inappropriate material.

As described above, there are a number of different embodiments in which the present invention may be implemented. However, regardless of the particular embodiment chosen, there are primary functional components that are the same in each of the embodiments. These components are now described with reference to FIG. 5.

FIG. 5 is an exemplary diagram illustrating the primary components of a monitoring agent in accordance with the present invention. The elements shown in FIG. 5 may be implemented in hardware, software, or any combination of hardware and software. In a preferred embodiment, the elements in FIG. 5 are implemented as software instructions executed by one or more processing devices. These software instructions and processing devices may be part of a data network gateway service provider, a client device, a dedicated service provider, or may be distributed across one or more of a data network gateway service provider, dedicated service provider and a client device.

As shown in FIG. 5, the monitoring agent of the present invention includes a controller 510, a log storage device interface 520, a user database interface 530, a log capture and storage device 540, a log report access device 550, a log report notification device 560, a log analysis device 570, and a log report output device 580. These elements 510-580 are coupled to one another by way of the control/data signal bus 590. Although a bus architecture is shown in FIG. 5, the present invention is not limited to such and any architecture that facilitates communication of control/data signals between the elements 510-580 may be used without departing from the spirit and scope of the present invention.

The controller 510 controls the overall operation of the monitoring agent and orchestrates the operation of the other elements 520-580. In operation, the controller 510 receives a request for log-on by a client device so that the client device may begin retrieval of content over the data network. The log-on request may include user identification information and password information that may be verified by information stored in the user database via the user database interface 530, for example.

Once the log-on request is verified, the controller 510 performs negotiation of a connection with the client device. As noted above, this negotiation includes a determination as to whether logs of content requests should be generated. This determination may involve a look-up of user information in the user database via the user database interface 530. For example, this look-up may involve retrieving a user database record and determining if a content request log field in the user database record indicates that a log should be generated.

If a log is to be generated, the content request is processed by the log capture and storage device 540 which generates the appropriate information for a log entry from the content request. This log entry is then stored in the log storage device via the log storage device interface 520. The content request is then repackaged and transmitted to the content provider by the controller 510.

When the content is returned by the content provider, the controller 510 may forward the content to the log capture and storage device 540 which may copy the content and store it in association with the log entry. The controller 510 may then forward the requested content to the client device. Alternatively, the controller 510 may instruct the log analysis device 570 to analyze the content to determine if it contains questionable subject matter. If so, the controller 510 may not forward the content to the client device and may forward a standardized error message instead. Also, rather than automatically storing copies of all the content received, the controller 510 may use the log analysis device 570 to determine if the content potentially contains inappropriate material and only then, store a copy of the content for later review by an authorized user.

In another embodiment, at the time the content request log entry is stored, or at some later time after the content request log has been stored in the log storage device, the log analysis device 570 may be used to analyze the content request log entries in order to provide aid to an authorized user in determining if inappropriate content is being requested by a monitored individual. The analysis may provide, among other possibilities, a ranked list of content providers from which content is requested, the most frequent content requests, etc. In order to perform such analysis, the log entries may be examined such that each content request appearing in the content request log is stored and a tally of each time that content request appears is kept. From these tallies, a ranked listing, such as those described above, may be generated for use by an individual monitoring the use of the client device by a monitored individual.

In addition, a date/time distribution of messages and tracking of content request patterns for a particular user identification may be provided through the log analysis device 570. For example, the timestamps of each log entry may be examined to determine at what times, days of the week, and the like, the user account is being used to retrieve content. From this, a pattern of activity may be plotted and provided to the individual monitoring the user account.

Moreover, the analysis of the content request logs may include filtering the transcripts for interesting or dangerous text such as offensive language, offensive content, known URLs having inappropriate content, etc. and the log analysis device 570 may have an ability to save a secondary content request log that is pre-indexed and filtered to remove irrelevant or harmless content requests. Such text filtering may include comparing words or phrases in the requested content to a dictionary of inappropriate or “red flag” words and phrases and marking them accordingly such that the are displayed or otherwise provided to the individual monitoring the user account in a conspicuous manner. Moreover, generating a secondary transcript file that is pre-indexed and filtered may include determining the instant messages having such “red flag” words and phrases and storing only those content requests in the secondary transcript file.

The log report access device 550 is responsible for generating and controlling the dissemination of content request log reports. The log report access device 550 determines when, whether, and where to transmit log reports. The determination of when to transmit a log report depends on the particular embodiment. As previously noted, this may include transmitting the content request log at predetermined times or upon the occurrence of an event, such as the termination of a web browsing session, an authorized user requesting the content request log, identification of inappropriate content, or the like. In addition, the log report access device 550 may perform access verification and authorization to determine if individuals logging onto the service provider and requesting reports are authorized to receive them. Such verification, in one exemplary embodiment, may include password verification.

The log report notification device 560 generates the log report, either periodically or in response to the occurrence of an event, and transmits the report by way of the log report output interface 580. The log report output interface 580 may be an electronic mail program, a web page, conventional mail, telephone or pager network interface, or the like.

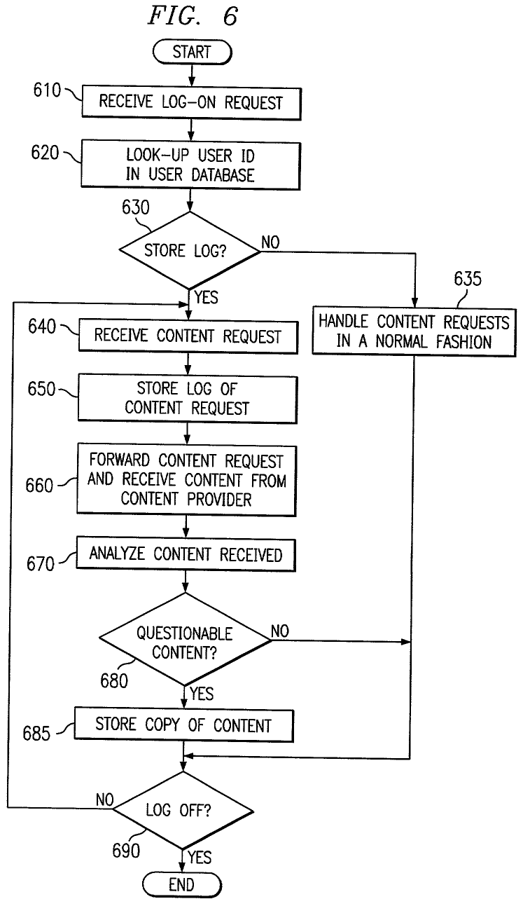

FIG. 6 is a flowchart outlining an exemplary operation of the present invention when storing a content request log. The steps shown in FIG. 6 are only exemplary. Many of the steps are optional and many may be performed in a different order than that shown in FIG. 6 without departing from the spirit and scope of the present invention. No limitation is intended or should be inferred by the steps shown in FIG. 6.

As shown in FIG. 6, the operation starts with receipt of a log-on request (step 610). The log-on request is then verified and assuming that the user is a verified user, a look-up of the user identification in the user database is performed (step 620). A determination is then made as to whether the user information from the user database indicates that a log should be stored (step 630). If not, content requests are handled in a normal fashion with no logging of the content requests (step 635).

If logs are to be stored, a content request is received (step 640) and a log of the content request is stored (step 650). The content request is then forwarded to the content provider and the requested content is received from the content provider (step 660).

In the particular embodiment shown, the content received is then analyzed to determine if it contains questionable subject matter (step 670). If it contains questionable subject matter (step 680), a copy of the content is stored (step 685). Otherwise, a copy of the content is not stored.

A determination is then made as to whether the user has logged off (step 690). This may be based on an actual request to log off or a period of time of inactivity. If the user has not logged off, the operation returns to step 640. Otherwise, the operation terminates.

FIG. 7 is a flowchart outlining an exemplary operation of the present invention when generating a log report for review by an authorized individual. The steps shown in FIG. 7 are only exemplary. Many of the steps are optional and many may be performed in a different order than that shown in FIG. 7 without departing from the spirit and scope of the present invention. No limitation is intended or should be inferred by the steps shown in FIG. 7.

As shown in FIG. 7, the operation starts with a determination as to whether a log report is to be generated (step 710). If not, the operation ends. Otherwise, a determination is made as to whether an analysis of the content request log is to be performed (step 720). If so, the analysis is performed on the content request log (step 730).

Thereafter, or if an analysis is not performed, the log report is generated (step 740). If an analysis is performed, the log report will reflect the results of the analysis. The log report is then transmitted to the authorized individual (step 750). As previously noted, this may involve sending a notification and/or the report by way of electronic mail, pager, telephone, regular mail, or the like.

Thus, the present invention provides a mechanism by which a user may be monitored to determine if inappropriate content is being requested by the user. Through the present invention, parents may view the content being requested by their children and thereby, make sure that the child is not getting involved in viewing inappropriate content.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media such a floppy disc, a hard disk drive, a RAM, and CD-ROMs and transmission-type media such as digital and analog communications links.

The description of the present invention has been presented for purposes of illustration and description, but is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method of monitoring content requested by a user of a client device, comprising:
receiving a content request;
determining if a log entry for the content request is to be stored;
storing the log entry in a storage device on a service provider if a log entry of the content request is to be stored; and
providing the log entry to a designated monitor of the client device.

2. The method of claim 1, wherein the service provider is a data network gateway service provider of a distributed data processing system.

3. The method of claim 1, further comprising:
analyzing the content requested by the content request to identify at least one characteristic of the content, wherein providing the log entry to a designated monitor includes providing information regarding the at least one characteristic of the content to the designated monitor.

4. The method of claim 1, wherein providing the log entry to a designated monitor includes transmitting the log entry as an attachment to an electronic mail message.

5. The method of claim 4, wherein the electronic mail message is transmitted in response to a request from the designated monitor.

6. The method of claim 1, wherein providing the log entry to a designated monitor includes generating a web page through which the log entry is provided to the designated monitor.

7. The method of claim 3, wherein analyzing the content includes filtering for specific textual patterns.

8. The method of claim 1, wherein determining if a log entry for the content request is to be stored includes:
looking up a user identification in a user database; and
determining if a log field indicates that a log is to be stored.

9. The method of claim 1, further comprising:
storing a copy of the content in association with the log entry.

10. The method of claim 1, further comprising:
receiving the content requested by the content request;
analyzing the content; and
forwarding the content to the client device based on a result of the analysis of the content.

11. The method of claim 10, wherein the content is not forwarded to the client device if the analysis of the content indicates that the content contains inappropriate subject matter.

12. The method of claim 1, wherein providing the log entry to the monitor of the client device includes sending a pager message.

13. The method of claim 1, wherein the log entry includes a Universal Resource Locator of the content request and zero or more of an Internet Protocol address, time and data of the content request.

14. The method of claim 10, wherein the log entry includes an indicator of whether or not the content requested by the content request was forwarded to the client device.

15. The method of claim 1, wherein the step of providing the log entry to a designated monitor of the client device is performed at a predetermined time interval.

16. The method of claim 1, wherein the step of providing the log entry to a designated monitor of the client device is performed immediately after the storing of the log entry in response to the storing of the log entry.

17. The method of claim 10, wherein if the analysis of the content indicates that the content contains inappropriate material, the method further comprises sending a standardized error web page to the client device.

18. A computer program product in a computer readable medium for monitoring content requested by a user of a client device, comprising:
first instructions for receiving a content request;
second instructions for determining if a log entry for the content request is to be stored;
third instructions for storing the log entry in a storage device on a service provider if a log entry of the content request is to be stored; and
fourth instructions for providing the log entry to a designated monitor of the client device.

19. The computer program product of claim 18, wherein the service provider is a data network gateway service provider of a distributed data processing system.

20. The computer program product of claim 18, further comprising:
fifth instructions for analyzing the content requested by the content request to identify at least one characteristic of the content, wherein the fourth instructions for providing the log entry to a designated monitor include instructions for providing information regarding the at least one characteristic of the content to the designated monitor.

21. The computer program product of claim 18, wherein the fourth instructions for providing the log entry to a designated monitor include instructions for transmitting the log entry as an attachment to an electronic mail message.

22. The computer program product of claim 21, wherein the electronic mail message is transmitted in response to a request from the designated monitor.

23. The computer program product of claim 18, wherein the fourth instructions for providing the log entry to a designated monitor include instructions for generating a web page through which the log entry is provided to the designated monitor.

24. The computer program product of claim 20, wherein the fifth instructions for analyzing the content include instructions for filtering for specific textual patterns.

25. The computer program product of claim 18, wherein the second instructions for determining if a log entry for the content request is to be stored include:
instructions for looking up a user identification in a user database; and
instructions for determining if a log field indicates that a log is to be stored.

26. The computer program product of claim 18, further comprising:
fifth instructions for storing a copy of the content in association with the log entry.

27. The computer program product of claim 18, further comprising:
fifth instructions for receiving the content requested by the content request;
sixth instructions for analyzing the content; and
seventh instructions for forwarding the content to the client device based on a result of the analysis of the content.

28. The computer program product of claim 27, wherein the content is not forwarded to the client device if the analysis of the content indicates that the content contains inappropriate subject matter.

29. The computer program product of claim 18, wherein the fourth instructions for providing the log entry to the monitor of the client device include instructions for sending a pager message.

30. The computer program product of claim 18, wherein the log entry includes a Universal Resource Locator of the content request and zero or more of an Internet Protocol address, time and data of the content request.

31. The computer program product of claim 27, wherein the log entry includes an indicator of whether or not the content requested by the content request was forwarded to the client device.

32. The computer program product of claim 18, wherein the fourth instructions for providing the log entry to a designated monitor of the client device are executed at a predetermined time interval.

33. The computer program product of claim 18, wherein the fourth instructions for providing the log entry to a designated monitor of the client device are executed immediately after the storing of the log entry in response to the storing of the log entry.

34. The computer program product of claim 27, further comprising eight instructions for sending a standardized error web page to the client device if the analysis of the content indicates that the content contains inappropriate material.

35. An apparatus for monitoring content requested by a user of a client device, comprising:
means for receiving a content request;
means for determining if a log entry for the content request is to be stored;
means for storing the log entry in a storage device on a service provider if a log entry of the content request is to be stored; and
means for providing the log entry to a designated monitor of the client device.
